(19) United States
(12) Patent Application Publication
(10) Pub. No.: US 2023/0217412 A1
(43) Pub. Date: Jul. 6, 2023

(54) MONITORING PAGING ON MULTIPLE BEAMS

(71) Applicant: QUALCOMM Incorporated, San Diego, CA (US)

(72) Inventors: Jinglin ZHANG, Shenzhen, Guangdong (CN); Haojun WANG, Xian, Shaanxi (CN); Zhanzhong YUAN, Shenzhen (CN); Tom CHIN, San Diego, CA (US); Yi LIU, Shenzhen (CN); Zhenqing CUI, Shenzhen, Guangdong (CN)

(21) Appl. No.: 18/000,494

(22) PCT Filed: Jul. 21, 2021
(86) PCT No.: PCT/CN2021/107528

§ 371 Date: Dec. 1, 2022

(30) Foreign Application Priority Data
Jul. 30, 2020 (WO) PCT/CN2020/105715
Jul. 31, 2020 (WO) PCT/CN2020/106060

(51) Int. Cl. H04W 68/02

(52) U.S. Cl. CPC H04W 68/02

(57) ABSTRACT

Various aspects of the present disclosure generally relate to wireless communication. In some aspects, a user equipment (UE) may monitor paging search spaces that correspond to beams other than a serving beam if a signal to interference plus noise ratio (SINR) of the serving beam does not satisfy a SINR threshold. The UE may stop the monitoring if a paging message in the paging search spaces has been successfully decoded. In some aspects, a UE may determine whether a paging search space that corresponds to a serving beam is a last paging search space in a first paging occasion, after the UE decoded a paging downlink control information and failed to decode a paging physical downlink shared channel on the serving beam. The UE may monitor paging search spaces, in a second paging occasion, that correspond to paging search spaces of the first paging occasion. Numerous other aspects are provided.

### CROSS-REFERENCE TO RELATED APPLICATIONS

This patent application claims priority to PCT Application No. PCT/CN2020/105715, filed on Jul. 30, 2020, entitled “MONITORING PAGING ON MULTIPLE BEAMS” and PCT Application No. PCT/CN2020/106060, filed on Jul. 31, 2020, entitled “BEAM SELECTION FOR A NEXT PAGING OCCASION,” and assigned to the assignee hereof. The disclosures of the prior applications are considered part of and are incorporated by reference into this patent application.

### FIELD OF THE DISCLOSURE

Aspects of the present disclosure generally relate to wireless communication and to techniques and apparatuses for monitoring paging on multiple beams.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, or a 5G Node B.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE, NR, and other radio access technologies.

### SUMMARY

In some aspects, a method of wireless communication performed by a user equipment (UE) includes monitoring one or more paging search spaces, in a paging occasion, that correspond to one or more beams other than a serving beam based at least in part on a determination that a signal to interference plus noise ratio (SINR) of the serving beam does not satisfy a first SINR threshold. The method includes stopping the monitoring of the one or more paging search spaces in the paging occasion based at least in part on a determination that a paging message in the one or more paging search spaces has been successfully decoded.

In some aspects, a UE for wireless communication includes a memory and one or more processors coupled to the memory. For example, the one or more processors may be operatively, electronically, communicatively, or otherwise coupled to the memory. The memory includes instructions executable by the one or more processors to cause the UE to monitor one or more paging search spaces, in a paging occasion, that correspond to one or more beams other than a serving beam based at least in part on a determination that an SINR of the serving beam does not satisfy a first SINR threshold, and stop the monitoring of the one or more paging search spaces in the paging occasion based at least in part on a determination that a paging message in the one or more paging search spaces has been successfully decoded.

In some aspects, a non-transitory computer-readable medium stores one or more instructions for wireless communication, the one or more instructions, when executed by one or more processors of a UE, cause the UE to monitor one or more paging search spaces, in a paging occasion, that correspond to one or more beams other than a serving beam based at least in part on a determination an SINR of the serving beam does not satisfy a first SINR threshold, and stop the monitoring of the one or more paging search spaces in the paging occasion based at least in part on a determination that a paging message in the one or more paging search spaces has been successfully decoded.

In some aspects, an apparatus for wireless communication includes means for monitoring one or more paging search spaces, in a paging occasion, that correspond to one or more beams other than a serving beam based at least in part on a determination that an SINR of the serving beam does not satisfy a first SINR threshold, and means for stopping the monitoring of the one or more paging search spaces in the paging occasion based at least in part on a determination that a paging message in the one or more paging search spaces has been successfully decoded.

In some aspects, a method of wireless communication performed by a UE includes determining that a paging search space that corresponds to a serving beam is a last paging search space in a first paging occasion, after determining that the UE decoded a paging downlink control information (DCI) in the paging search space and failed to decode a paging physical downlink shared channel (PDSCH) on the serving beam, and determining one or more beams that correspond to one or more paging search spaces of the first paging occasion based at least in part on the determining that the paging search space is the last paging search space in the first paging occasion. Each beam of the one or more beams may satisfy a signal to interference plus noise ratio (SINR) threshold. The method includes monitoring one or more paging search spaces, in a second paging occasion, that correspond to the one or more beams.

In some aspects, a UE for wireless communication includes a memory and one or more processors coupled to the memory. For example, the one or more processors may be operatively, electronically, communicatively, or otherwise coupled to the memory. The memory includes instructions executable by the one or more processors to cause the UE to determine that a paging search space that corresponds to a serving beam is a last paging search space in a first paging occasion, after determining that the UE decoded a paging DCI in the paging search space and failed to decode a paging PDSCH on the serving beam. The memory includes instructions executable by the one or more processors to cause the UE to determine one or more beams that correspond to one or more paging search spaces of the first paging occasion based at least in part on the determining that the paging search space is the last paging search space in the first paging occasion, where each beam of the one or more beams satisfies an SINR threshold. The memory includes instructions executable by the one or more processors to cause the UE to monitor one or more paging search spaces, in a second paging occasion, that correspond to the one or more beams.

In some aspects, a non-transitory computer-readable medium stores one or more instructions for wireless communication, where the one or more instructions, when executed by one or more processors of a UE, cause the UE to determine that a paging search space that corresponds to a serving beam is a last paging search space in a first paging occasion, after determining that the UE decoded a paging DCI in the paging search space and failed to decode a paging PDSCH on the serving beam, determine one or more beams that correspond to one or more paging search spaces of the first paging occasion based at least in part on the determining that the paging search space is the last paging search space in the first paging occasion, where each beam of the one or more beams satisfies an SINR threshold, and monitor one or more paging search spaces, in a second paging occasion, that correspond to the one or more beams.

In some aspects, an apparatus for wireless communication includes means for determining that a paging search space that corresponds to a serving beam is a last paging search space in a first paging occasion, after determining that the apparatus decoded a paging DCI in the paging search space and failed to decode a paging physical downlink shared channel on the serving beam, means for determining one or more beams that correspond to one or more paging search spaces of the first paging occasion based at least in part on the determining that the paging search space is the last paging search space in the first paging occasion, where each beam of the one or more beams satisfies an SINR threshold, and means for monitoring one or more paging search spaces, in a second paging occasion, that correspond to the one or more beams.

In some aspects, a method of wireless communication performed by a UE includes determining that a paging search space that corresponds to a serving beam is not a last paging search space in a first paging occasion, after determining that the UE decoded a paging DCI in the paging search space and failed to decode a paging PDSCH on the serving beam, and monitoring one or more remaining paging search spaces in the first paging occasion. The method includes determining one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion. Each beam of the one or more beams satisfies an SINR threshold. The method includes monitoring one or more paging search spaces, in a second paging occasion, that correspond to the one or more beams.

In some aspects, a UE for wireless communication includes a memory and one or more processors coupled to the memory. For example, the one or more processors may be operatively, electronically, communicatively, or otherwise coupled to the memory. The memory includes instructions executable by the one or more processors to cause the UE to determine that a paging search space that corresponds to a serving beam is not a last paging search space in a first paging occasion, after determining that the UE decoded a paging DCI in the paging search space and failed to decode a paging PDSCH on the serving beam, monitor one or more remaining paging search spaces in the first paging occasion, determine one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, where each beam of the one or more beams satisfies an SINR threshold. and monitor one or more paging search spaces, in a second paging occasion, that correspond to the one or more beams.

In some aspects, a non-transitory computer-readable medium stores one or more instructions for wireless communication, the one or more instructions, when executed by one or more processors of a UE, cause the UE to determine that a paging search space that corresponds to a serving beam is not a last paging search space in a first paging occasion, after determining that the UE decoded a paging downlink control information in the paging search space and failed to decode a paging PDSCH on the serving beam, monitor one or more remaining paging search spaces in the first paging occasion, determine one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, where each beam of the one or more beams satisfies an SINR threshold, and monitor one or more paging search spaces, in a second paging occasion, that correspond to the one or more beams.

In some aspects, an apparatus for wireless communication includes means for determining that a paging search space that corresponds to a serving beam is not a last paging search space in a first paging occasion, after determining that the apparatus decoded a paging downlink control information in the paging search space and failed to decode a paging PDSCH on the serving beam, means for monitoring one or more remaining paging search spaces in the first paging occasion, means for determining one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, where each beam of the one or more beams satisfies an SINR threshold, and means for monitoring one or more paging search spaces, in a second paging occasion, that correspond to the one or more beams.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of paging search spaces in a paging occasion, in accordance with the present disclosure.

FIG. 4 is a diagram illustrating an example of monitoring paging on multiple beams, in accordance with the present disclosure.

FIGS. 5A-5B are diagrams illustrating an example of monitoring paging on multiple beams, in accordance with the present disclosure.

FIG. 6 is a diagram illustrating an example process performed, for example, by a UE, in accordance with the present disclosure.

FIGS. 7A-7B are diagrams illustrating an example of selecting beams for a next paging occasion, in accordance with the present disclosure.

FIGS. 8A-8B are diagrams illustrating an example of selecting beams for a next paging occasion, in accordance with the present disclosure.

FIG. 9 is a diagram illustrating an example of using a monitor flag, in accordance with the present disclosure.

FIG. 10 is a diagram illustrating an example of a process for monitoring a serving beam only, in accordance with the present disclosure.

FIG. 11 is a diagram illustrating an example of a process for monitoring multiple beams, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

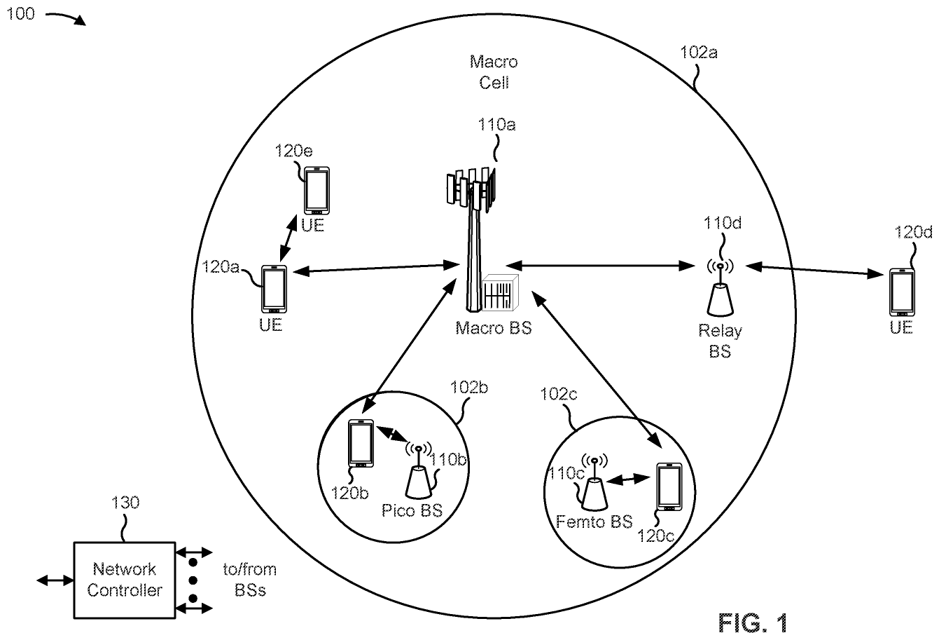

FIG. 1 is a diagram illustrating an example of a wireless network 100 in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, or a transmit receive point (TRP). Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, or a virtual network using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, or a relay.

Wireless network 100 may be a heterogeneous network that includes BSs of different types, such as macro BSs, pico BSs, femto BSs, and/or relay BSs. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, and/or an air interface. A frequency may also be referred to as a carrier, and/or a frequency channel. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

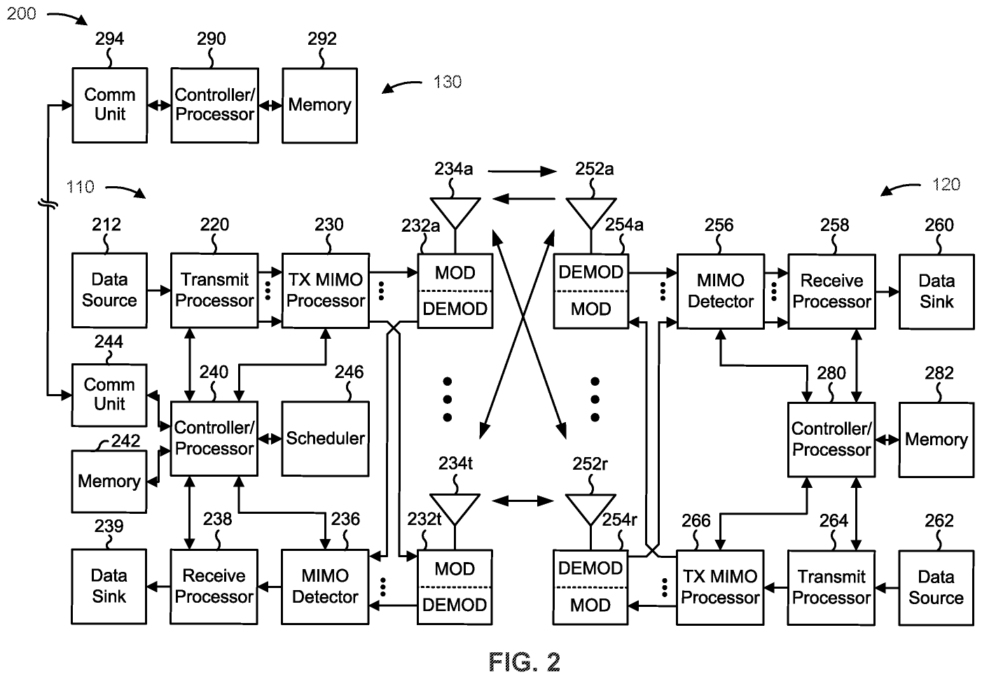

FIG. 2 is a diagram illustrating an example 200 of abase station 110 in communication with a UE 120 in a wireless network 100, in accordance with the present disclosure. Base station 110 may be equipped with T antennas 234a through 234t, and UE 120 may be equipped with R antennas 252a through 252r, where in generalT≥1 andR≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, upper layer signaling) and provide overhead symbols and control symbols. Transmit processor 220 may also generate reference symbols for reference signals (e.g., a cell-specific reference signal (CRS), a demodulation reference signal (DMRS)) and synchronization signals (e.g., the primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), and/or CQI, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

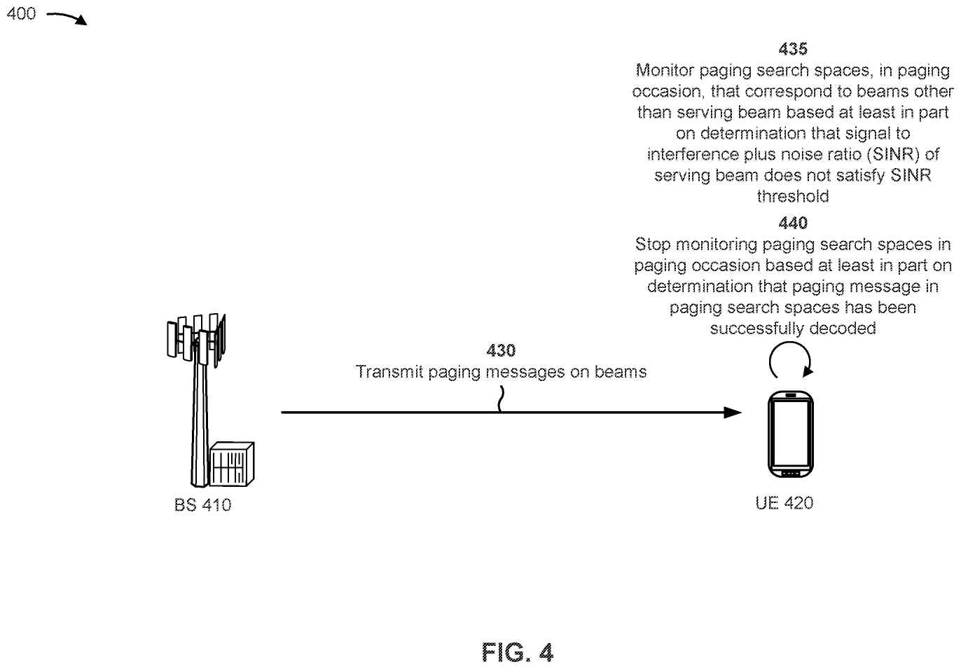

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-6).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-6).

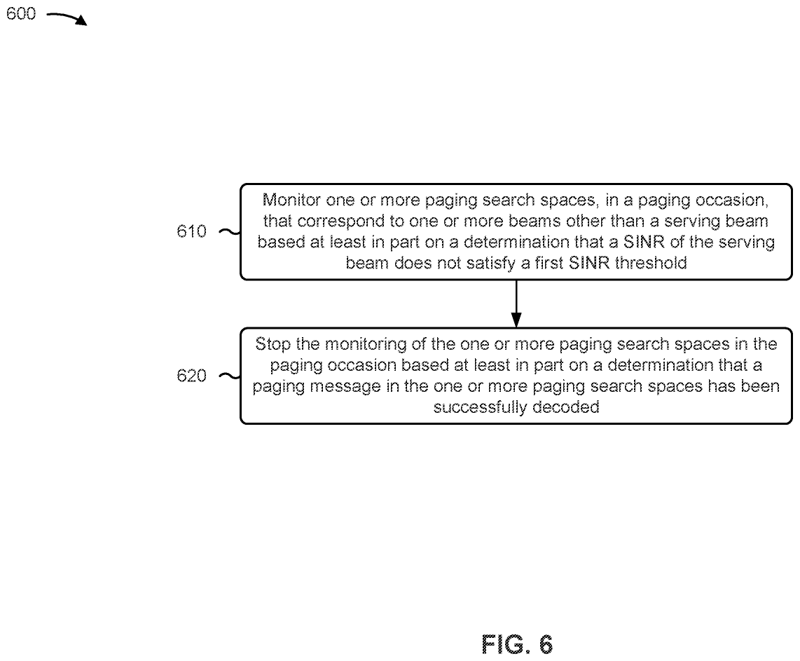

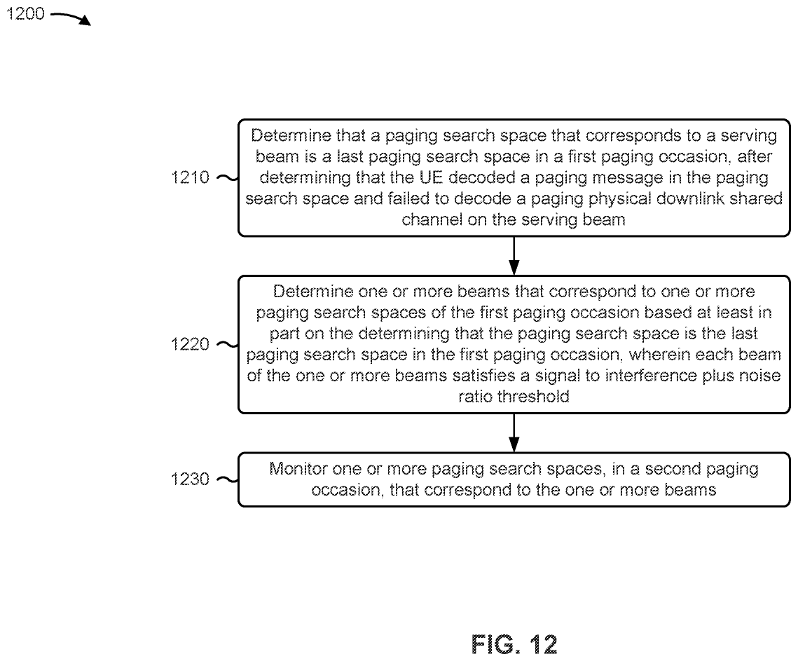

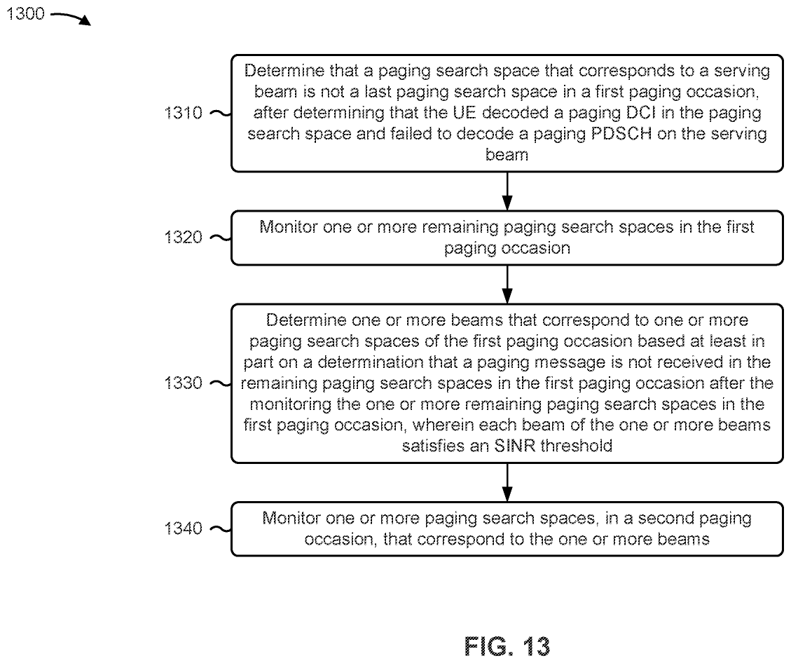

Controller/processor 240 of base station 110, controller/processor 280 of UE 120, and/or any other component(s) of FIG. 2 may perform one or more techniques associated with monitoring paging on multiple beams or selecting beams for a next paging occasion, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 1200 of FIG. 12, process 1300 of FIG. 13, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of base station 110 and/or UE 120, may cause the one or more processors, UE 120, and/or base station 110 to perform or direct operations of, for example, process 600 of FIG. 6, process 1200 of FIG. 12, process 1300 of FIG. 13, and/or other processes as described herein. In some aspects, executing instructions may include running the instructions, converting the instructions, compiling the instructions, and/or interpreting the instructions, among other examples.

In some aspects, UE 120 may include means for monitoring one or more paging search spaces, in a paging occasion, that correspond to one or more beams other than a serving beam based at least in part on a determination that a signal to interference plus noise ratio (SINR) of the serving beam does not satisfy a first SINR threshold, and/or means for stopping the monitoring of the one or more paging search spaces in the paging occasion based at least in part on a determination that a paging message in the one or more paging search spaces has been successfully decoded. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258.

In some aspects, UE 120 may include means for determining that a paging search space that corresponds to a serving beam is a last paging search space in a first paging occasion, after determining that the UE decoded a paging downlink control information (DCI) in the paging search space and failed to decode a paging physical downlink shared channel (PDSCH) on the serving beam, means for determining one or more beams that correspond to one or more paging search spaces of the first paging occasion based at least in part on the determining that the paging search space is the last paging search space in the first paging occasion, where each beam of the one or more beams satisfies a signal to interference plus noise ratio (SINR) threshold, and/or means for monitoring one or more paging search spaces, in a second paging occasion, that correspond to the one or more beams. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258.

In some aspects, UE 120 may include means for determining that a paging search space that corresponds to a serving beam is not a last paging search space in a first paging occasion, after determining that the UE decoded a paging DCI in the paging search space and failed to decode a paging PDSCH on the serving beam, means for monitoring one or more remaining paging search spaces in the first paging occasion, means for determining one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, where each beam of the one or more beams satisfies an SINR threshold, and/or means for monitoring one or more paging search spaces, in a second paging occasion, that correspond to the one or more beams. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, and/or receive processor 258.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MLMO processor 266 may be performed by or under the control of controller/processor 280.

As indicated above, FIG. 2 is provided as an example. Other examples may differ from what is described with regard to FIG. 2.

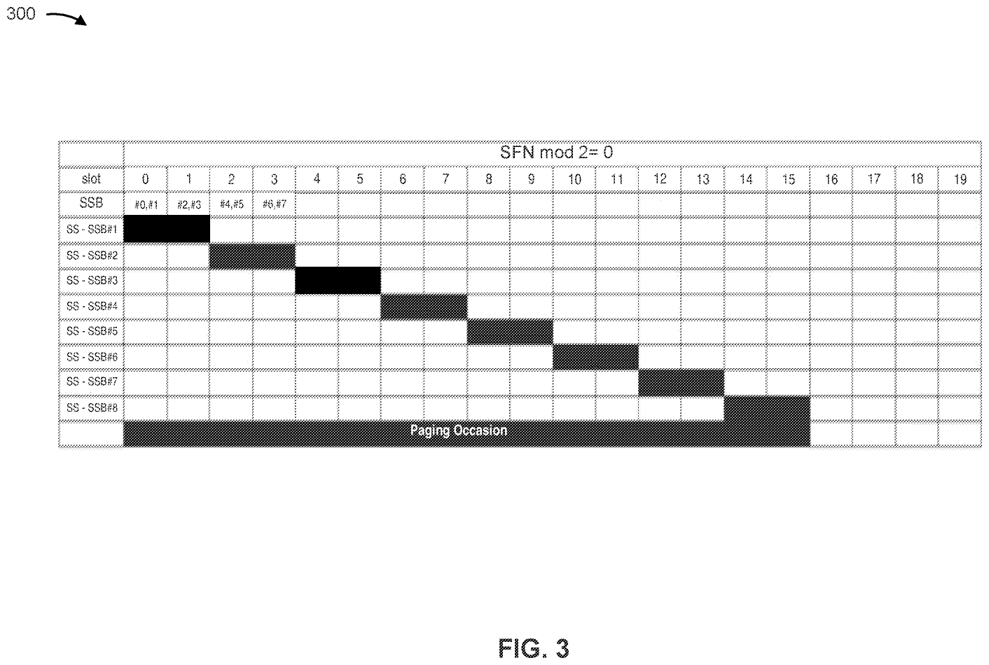

FIG. 3 is a diagram illustrating an example 300 of paging search spaces in a paging occasion, in accordance with the present disclosure.

In NR, a base station may repeat the same paging message and short message in multiple beams. It is up to a UE to determine how to receive the paging message. Example 300 is a table showing a paging occasion during which the UE may monitor for a paging message. The table is for FR1 with a subcarrier spacing of 30 kilohertz and shows there may be eight paging search spaces for synchronization signal blocks (SS-SSBs) in the paging occasion. Each paging search space may correspond to a beam, and SSBs may be used to indicate beams. A first paging search space may be a common search space.

A paging search space in example 300 is two slots, but a paging search space may be a different quantity of slots, depending on the configuration for the paging occasion. If the UE is to monitor all paging search spaces corresponding to all of the beams, then the UE monitors 16 continuous slots. If the UE is to monitor the serving beam only, then the UE monitors only two slots.

The UE may monitor a paging search space that corresponds to the serving beam. Normally, the serving beam may be the beam with the best RSRP, but this does not take into consideration a RSRQ or an SINR of the serving beam (e.g., SSB SINR). If the serving beam suffers interference from an overlapping beam or another object, the UE may not receive a paging message when the UE monitors the paging search space only for the serving beam. In multi-beam operations, each beam may have a different paging search space, and if the UE has to monitor all of the paging search spaces for a paging message, the UE may increase power consumption. In other words, the UE may consume power, processing resources, and signaling resources monitoring all paging search spaces or waste time, power, processing resources, and signaling resources by not successfully receiving a paging message at all.

As indicated above, FIG. 3 is provided as an example. Other examples may differ from what is described with regard to FIG. 3.

FIG. 4 is a diagram illustrating example 400 of monitoring paging on multiple beams, in accordance with the present disclosure. As shown in FIG. 4, example 400 includes communication between BS 410 (e.g., a BS 110 depicted in FIGS. 1 and 2) and a UE 420 (e.g., a UE 120 depicted in FIGS. 1 and 2). In some aspects, BS 410 and UE 420 may be included in a wireless network, such as wireless network 100. BS 410 and UE 420 may communicate on a wireless access link, which may include an uplink and a downlink.

Even though a serving beam may be a stronger signal, there may be too much interference to successfully decode an SSB in a paging message on the serving beam. According to various aspects described herein, a UE may monitor paging search spaces for other beams during a paging occasion when an SINR of the serving beam is below a first SINR threshold. The UE may select, as the other beams, beams that satisfy a second SINR threshold that is less than or equal to the first SINR threshold. In this way, the UE is monitoring paging search spaces corresponding to beams that may have less interference than the serving beam, and the UE is not necessarily monitoring all of the paging search spaces. In fact, there may be a maximum quantity of beams or paging search spaces to monitor in a paging occasion. In some aspects, beams may be selected in an order of descending SINR (beams with less interference first), which may give the UE a better chance of receiving a paging message sooner. In this way, the UE may successfully receive a paging message while monitoring fewer beams. As a result, paging performance is improved, and the UE conserves time, power, processing resources, and signaling resources.

As shown by reference number 430, BS 410 may transmit paging messages on beams that are configured for providing the paging messages. As shown by reference number 435, UE 420 may determine that a serving beam has an SINR that does not satisfy a SINR threshold (e.g., minimum SINR in decibels or decibel-milliwatts) and thus UE 420 may monitor paging search spaces that correspond to beams other than the serving beam. The SINR threshold may be configurable and may be used to judge whether monitoring should take place on multiple beams. There may be a maximum quantity of other beams to monitor. For example, the maximum quantity may be less than eight for FR1 and less than 64 for FR2. The other beams may be selected only if a SINR is above another configurable SINR threshold. Otherwise, UE 420 may monitor beams with more interference. This SINR threshold may be less than or equal to the SINR threshold used for the serving beam. While the operations discussed herein involve SINR thresholds, in some aspects, operations may also involve, alternatively or additionally, RSRQ thresholds. In some aspects, RSRP thresholds may be used for the serving beam and/or the other beams.

In some aspects, UE 420 may monitor paging search spaces in an order that corresponds to a descending order of SINR for the other beams. Better beams may be monitored first, rather than stepping through a regular order of beams. In some aspects, UE 420 may monitor paging search spaces in an increasing order of beam index or SSB identifier. For example, the selected beams may be {5, 3, 1}, where SINR of SSB #5>SSB #3>SSB #1. UE 420 may first monitor, in the next paging occasion, a paging search space that corresponds to beam 1, then a paging search space for beam 3, and then a paging search space for beam 5. In sum, UE 420 may search a quantity of paging search spaces that gives UE 420 a chance of successfully receiving a paging message while not wasting time, power, processing resources, and signaling resources by monitoring beams that have less chance of success.

As shown by reference number 440, UE 420 may stop monitoring paging search spaces based at least in part on a determination that a paging message in one of the paging search spaces is successfully decoded. For example, an SSB may have been successfully decoded. Otherwise, UE 420 continues to monitor paging search spaces for selected beams in the paging occasion. If UE 420 is not successful in receiving a paging message during the paging occasion, UE 420 continues to the next paging occasion.

As indicated above, FIG. 4 is provided as an example. Other examples may differ from what is described with regard to FIG. 4.

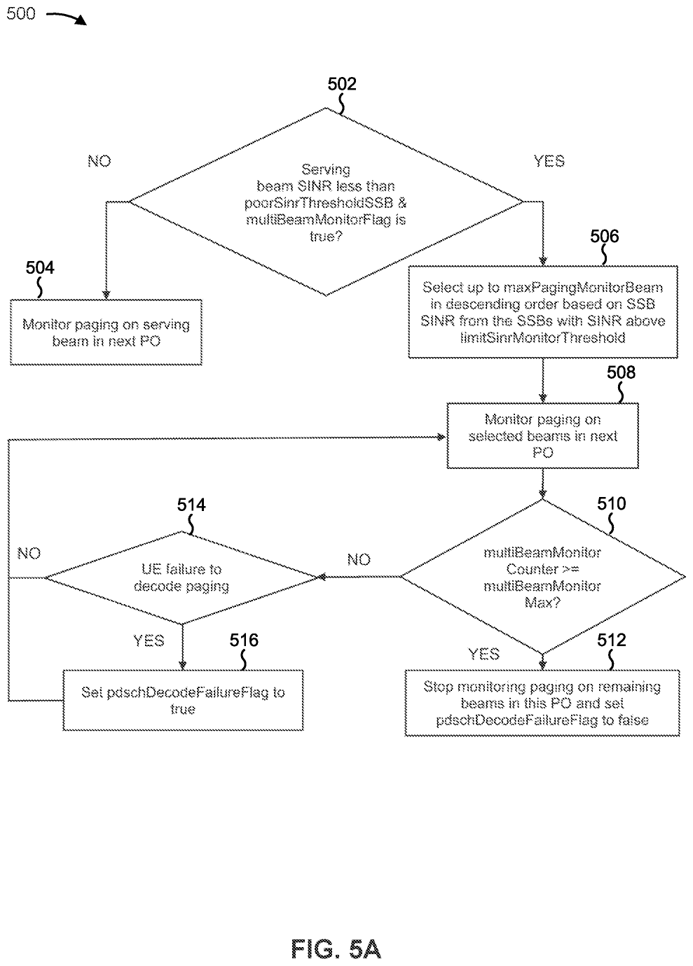

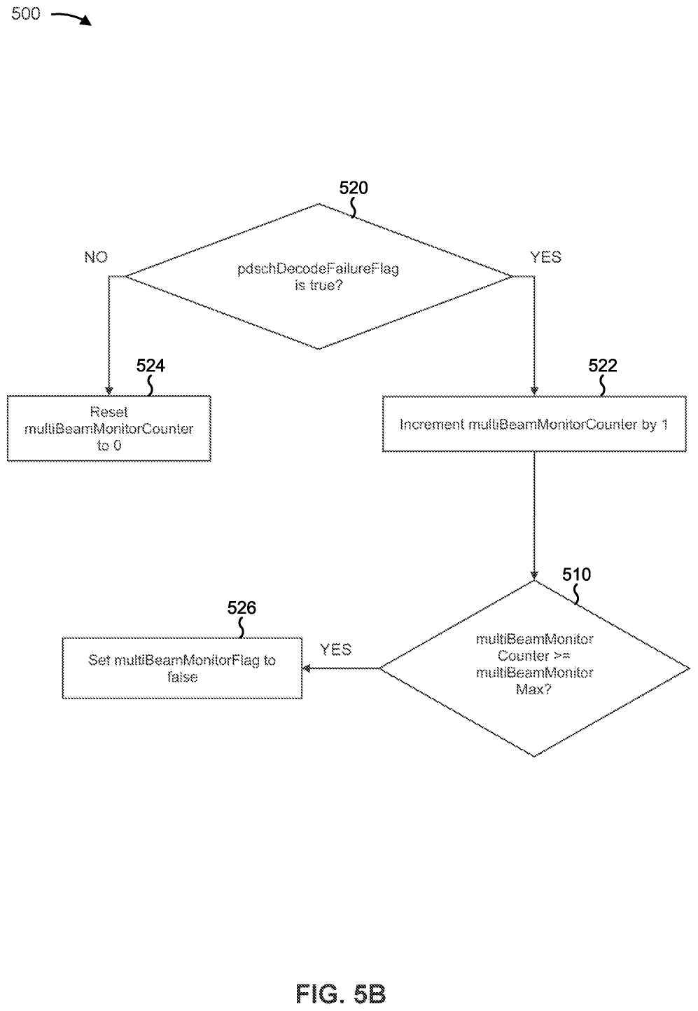

FIGS. 5A-5B are diagrams illustrating an example 500 of monitoring paging on multiple beams, in accordance with the present disclosure. FIGS. 5A-5B show flowcharts for how a UE may monitor paging search spaces in a paging occasion.

As shown by reference number 502, if the serving beam has an SINR that is equal to or greater than a first SINR threshold (e.g., poorSinrThresholdSSB), the UE may monitor a paging search space that corresponds to the serving beam, as shown by reference number 504. The first SINR threshold may be used to determine whether to monitor paging on multiple beams. If the serving beam has an SINR that is less than the first SINR threshold, the UE may monitor paging search spaces in the paging occasion that correspond to other beams, as shown by reference number 506. This may involve selecting beams that satisfy a second SINR threshold (e.g., limitSinrMonitorThreshold) and arranging the selected beams in a descending order by SINR. The second SINR threshold may be used to select beams for monitoring paging search spaces. As shown by reference number 508, the UE may monitor paging search spaces that correspond to the selected beams, in the arranged order. There may be a maximum quantity of beams (e.g., 64 beams) to monitor (e.g., maxPagingMonitorBeam).

In some aspects, the UE may stop using multiple beams in a cell in which all beams cannot decode a paging successfully. In such a case, if the UE keeps monitoring multiple beams when such monitoring is not necessary, the UE may increase power consumption. For example, the UE may monitor a paging search space that corresponds to the serving beam if the serving beam has an SINR that is less than the first SINR threshold and a multiple beam monitor flag (e.g., multiBeamMonitorFlag) is true. The UE may not monitor the paging search space that corresponds to the serving beam if the multiple beam monitor flag is false. In this case, some initial settings may include an initial value of 0 for a multi-beam monitor counter (e.g., multiBeamMonitorCounter), an initial value of true for a multi-beam monitor flag (e.g., multiBeamMonitorFlag) when the UE enters a new NR cell, and an initial value of false for a PDSCH decoding failure flag (e.g., pdschDecodeFailureFlag). A maximum counter value (e.g., multiBeamMonitorMax) may be configurable.

As shown by reference number 510, if the multi-beam monitor counter is greater than or equal to the maximum counter value, the UE may stop monitoring for a paging message, as shown by reference number 512. The UE may set the PDSCH decoding failure flag to false. If the UE is not successful, the UE may continue to monitor paging search spaces that were selected for the paging occasion. In some aspects, as shown by reference number 514, if the UE is not successful, the UE may set the PDSCH decoding failure flag to true if the UE fails to decode a paging PDSCH (e.g., P-RNTI scramble DCI received and corresponds to CRC failure), as shown by reference number 516.

In some aspects, as shown by reference number 520 in FIG. 5B, if the PDSCH decoding failure flag is set to true, the UE may increment the multi-beam monitor counter by 1, as shown by reference number 522. If the PDSCH decoding failure flag is not set to true, the UE may reset the multi-beam monitor counter to 0, as shown by reference number 524.

As shown by reference number 510, if the multi-beam monitor counter is greater than or equal to the maximum counter value, the UE may also set the multi-beam monitor flag to false, as shown by reference number 526.

As indicated above, FIGS. 5A-5B provided examples. Other examples may differ from what is described with regard to FIGS. 5A-5B.

FIG. 6 is a diagram illustrating an example process 600 performed, for example, by a UE, in accordance with the present disclosure. Example process 600 is an example where the UE (e.g., a UE 120 depicted in FIGS. 1 and 2. UE 420 depicted in FIG. 4) performs operations associated with monitoring paging on multiple beams.

As shown in FIG. 6, in some aspects, process 600 may include monitoring one or more paging search spaces, in a paging occasion, that correspond to one or more beams other than a serving beam based at least in part on a determination that an SINR of the serving beam does not satisfy a first SINR threshold (block 610). For example, the UE (e.g., using antenna 252, demodulator 254, MIMO detector 256, receive processor 258, transmit processor 264, TX MIMO processor 266, modulator 254, controller/processor 280, and/or memory 282) may monitor one or more paging search spaces, in a paging occasion, that correspond to one or more beams other than a serving beam based at least in part on a determination that an SINR of the serving beam does not satisfy a first SINR threshold, as described above.

As further shown in FIG. 6, in some aspects, process 600 may include stopping the monitoring of the one or more paging search spaces in the paging occasion based at least in part on a determination that a paging message in the one or more paging search spaces has been successfully decoded (block 620). For example, the UE (e.g., using antenna 252, demodulator 254, MIMO detector 256, receive processor 258, transmit processor 264, TX MIMO processor 266, modulator 254, controller/processor 280, and/or memory 282) may stop the monitoring of the one or more paging search spaces in the paging occasion based at least in part on a determination that a paging message in the one or more paging search spaces has been successfully decoded, as described above.

Process 600 may include additional aspects, such as any single aspect or any combination of aspects described below and/or in connection with one or more other processes described elsewhere herein.

In a first aspect, the paging message includes an SSB.

In a second aspect, alone or in combination with the first aspect, process 600 includes selecting the one or more beams such that each beam of the one or more beams satisfies a second SINR threshold.

In a third aspect, alone or in combination with one or more of the first and second aspects, a quantity of the one or more beams does not exceed a maximum quantity of beams.

In a fourth aspect, alone or in combination with one or more of the first through third aspects, the monitoring the one or more paging search spaces includes monitoring the one or more paging search spaces in an order that is based at least in part on a descending order of SINR for the one or more beams that correspond to the one or more paging search spaces.

In a fifth aspect, alone or in combination with one or more of the first through fourth aspects, the monitoring the one or more paging search spaces includes monitoring the one or more paging search spaces further based at least in part on a determination that a monitor flag to indicate multiple beam monitoring is true.

In a sixth aspect, alone or in combination with one or more of the first through fifth aspects, process 600 includes setting a monitor flag to indicate multiple beam monitoring to be true based at least in part on a determination that the UE has entered a new cell.

In a seventh aspect, alone or in combination with one or more of the first through sixth aspects, process 600 includes incrementing a multiple beam monitoring counter based at least in part on a determination that a PDSCH decoding failure flag is true.

In an eighth aspect, alone or in combination with one or more of the first through seventh aspects, process 600 includes setting a monitor flag to indicate multiple beam monitoring to be false based at least in part on a determination that the multiple beam monitoring counter satisfies a counter threshold.

In a ninth aspect, alone or in combination with one or more of the first through eighth aspects, process 600 includes setting a physical downlink shared channel decoding failure flag to false.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

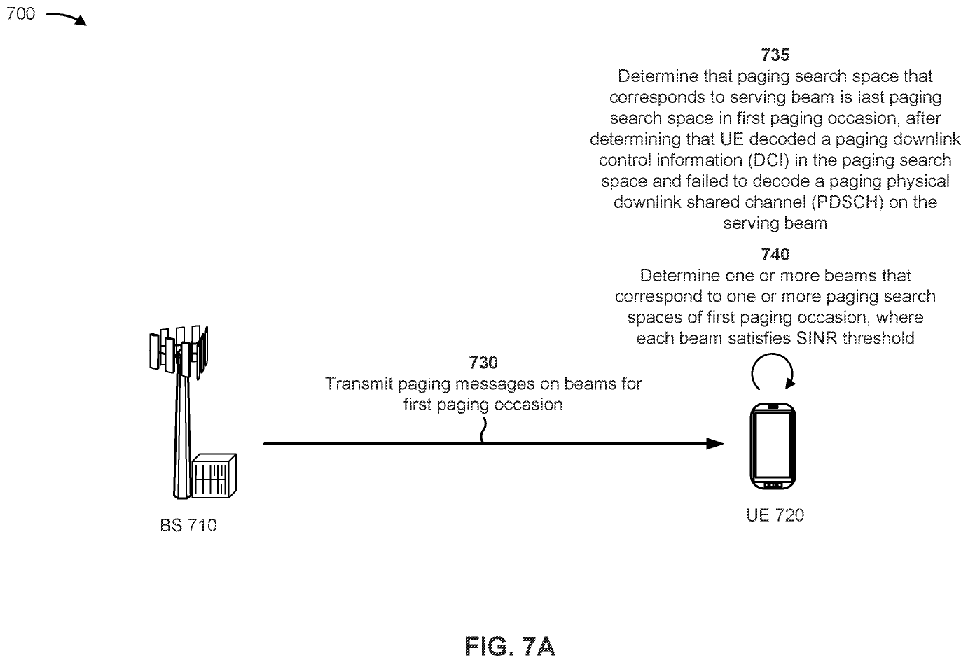

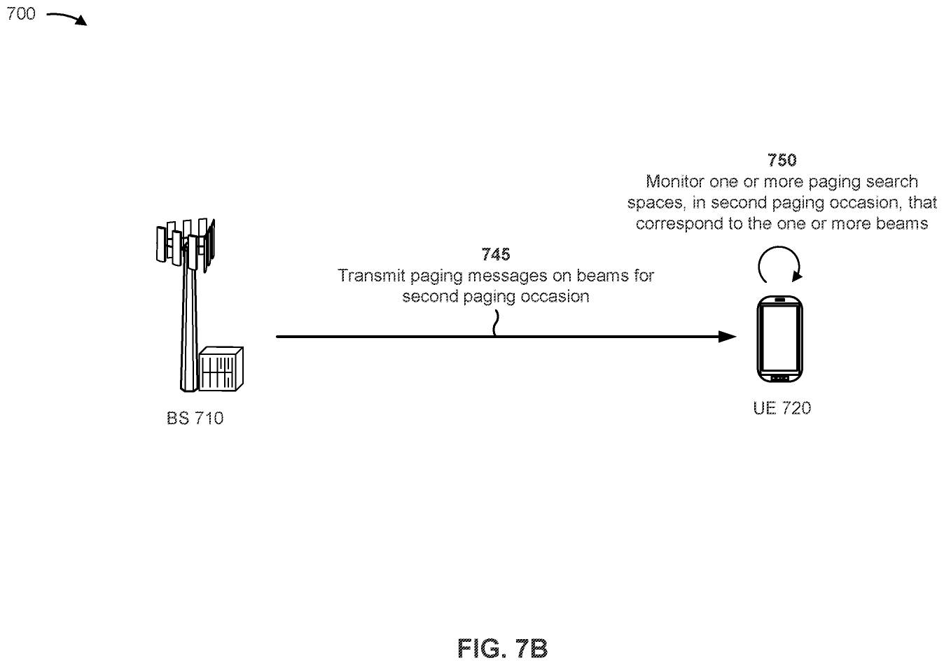

FIGS. 7A-7B are diagrams illustrating an example 700 of selecting beams for a next paging occasion, in accordance with the present disclosure. As shown in FIGS. 7A-7B, example 700 includes communication between BS 710 (e.g., a BS 110 depicted in FIGS. 1 and 2) and a UE 720 (e.g., a UE 120 depicted in FIGS. 1 and 2). In some aspects, BS 710 and UE 720 may be included in a wireless network, such as wireless network 100. BS 710 and UE 720 may communicate on a wireless access link, which may include an uplink and a downlink.

A UE may monitor a paging search space that corresponds to a serving beam. If the serving beam suffers intra-cell or inter-cell interference, the UE may fail to decode the PDSCH, even though the UE decoded a paging DCI (e.g., DCI1_0 scrambled with a paging radio network temporary identifier). The network may send paging messages again to the UE after a discontinuous reception (DRX) cycle. However, a DRX cycle may be, at a minimum, 320 milliseconds, and it may be some time before the UE is able to successfully receive a paging message (e.g., both paging DCI and PDSCH). This may cause paging latency and possibly cause paging to fail altogether. As a result, the UE may waste time, power, processing resources, and signaling resources due to the paging latency or due to not successfully receiving a paging message at all.

According to various aspects described herein, if a UE decodes a paging DCI in a paging search space that corresponds to a serving beam but fails to decode a paging PDSCH, the UE may determine whether a paging search space that corresponds to a serving beam is a last paging search space in a paging occasion. If the paging search space is the last one, the UE may select one or more beams that satisfy an SINR threshold, and monitor paging search spaces that correspond to the selected beams in a next paging occasion. The UE is monitoring paging search spaces corresponding to beams that may have less interference than the serving beam, and the UE is not necessarily monitoring all of the paging search spaces. In some aspects, the UE may monitor paging search spaces for the beams in the next paging occasion in an order of descending SINR (beams with less interference first), which may give the UE a better chance of receiving a paging message sooner. In this way, the UE may successfully receive a paging message in the next paging occasion while reducing paging latency. As a result, paging performance is improved, and the UE conserves time, power, processing resources, and signaling resources.

As shown in FIG. 7A and by reference number 730, BS 710 may transmit, in a first paging occasion, paging messages on beams that are configured for the paging messages. As shown by reference number 735, UE 720 may decode a paging DCI in a paging search space that corresponds to the serving beam and may fail to decode a paging PDSCH on the serving beam. UE 720 may then determine whether the paging search space that corresponds to the serving beam is a last paging search space in the first paging occasion.

As shown by reference number 740, UE 720 may determine one or more beams that correspond to one or more paging search spaces of the first paging occasion. Each beam of the one or more beams may satisfy an SINR threshold, and there may be a maximum quantity of beams to monitor. While the operations discussed herein involve SINR thresholds, in some aspects, operations may also involve, alternatively or additionally, RSRQ thresholds. In some aspects, UE 720 may select beams based at least in part on a descending order of SINR.

As shown in FIG. 7B and by reference number 745, BS 710 may transmit paging messages on beams for a second paging occasion, which may be the next paging occasion after the first paging occasion. As shown by reference number 750, UE 720 may monitor one or more paging search spaces, in the second paging occasion, that correspond to the one or more beams that were selected by UE 720 for the second paging occasion. UE 720 may stop monitoring paging search spaces when a paging message on the PDSCH is successfully decoded. In some aspects, UE 720 may monitor paging search spaces in an increasing order of beam index or SSB identifier. For example, the selected beams may be {5, 3, 1}, where an SINR of SSB #5>SSB #3>SSB #1. Accordingly, UE 720 may first monitor, in the next paging occasion, a paging search space that corresponds to beam 1, a paging search space for beam 3, and then a paging search space for beam 5.

As indicated above, FIGS. 7A-7B are provided as an example. Other examples may differ from what is described with regard to FIGS. 7A-7B.

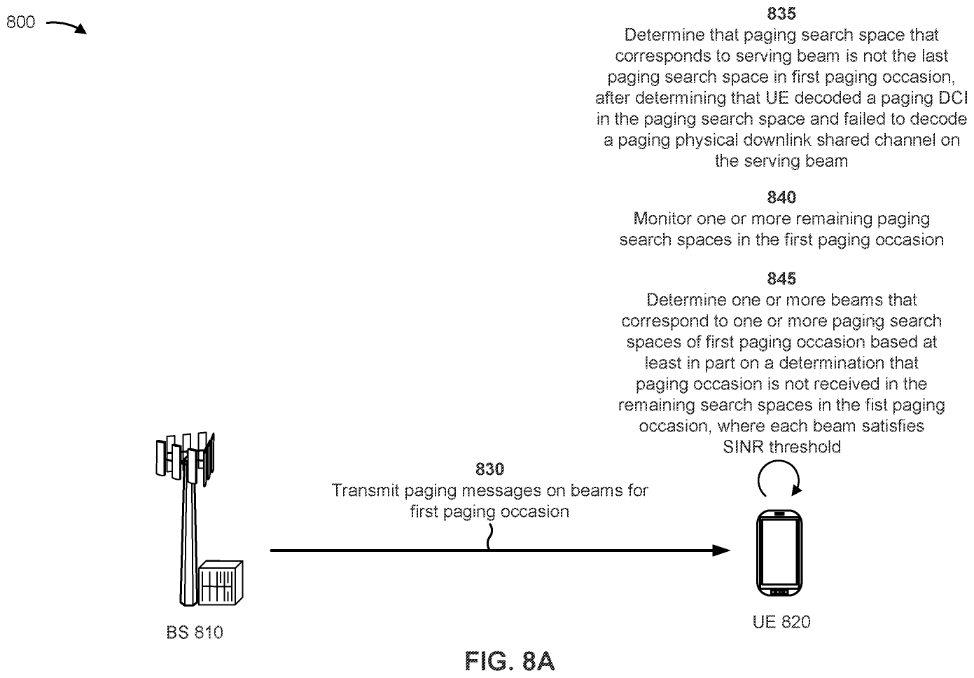

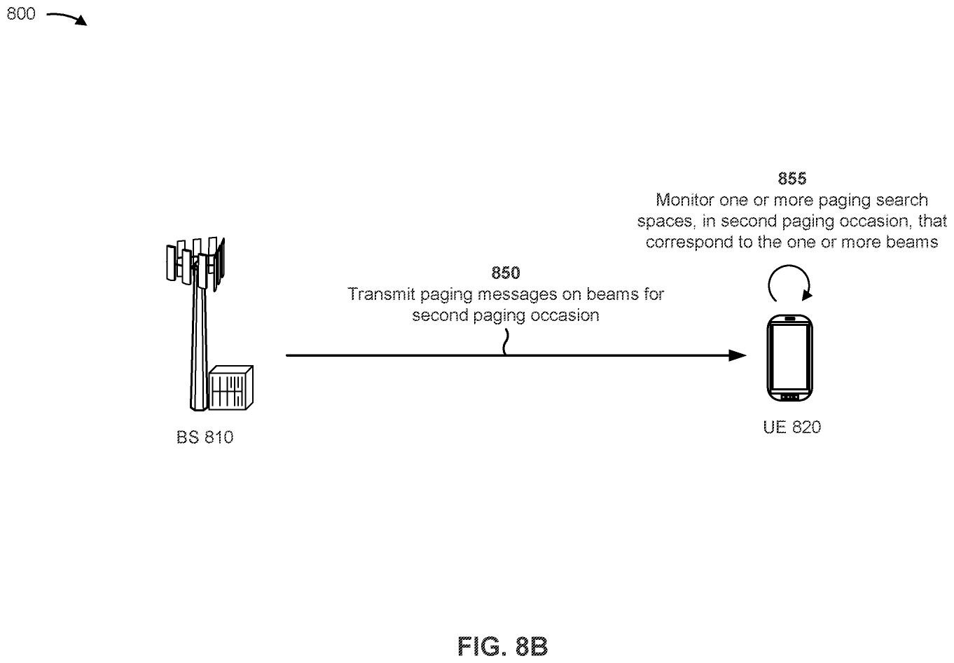

FIGS. 8A-8B are diagrams illustrating an example 800 of selecting beams for a next paging occasion, in accordance with the present disclosure. As shown in FIGS. 8A-8B, example 800 includes communication between BS 810 (e.g., a BS 110 depicted in FIGS. 1 and 2) and a UE 820 (e.g., a UE 120 depicted in FIGS. 1 and 2). In some aspects, BS 810 and UE 820 may be included in a wireless network, such as wireless network 100. BS 810 and UE 820 may communicate on a wireless access link, which may include an uplink and a downlink.

According to various aspects described herein, if a UE decodes a paging DCI in a paging search space that corresponds to a serving beam but fails to decode a paging PDSCH, the UE may determine whether a paging search space that corresponds to a serving beam is a last paging search space in a paging occasion. If the paging search space is not the last one, the UE may monitoring one or more remaining paging search spaces in the first paging occasion, If a paging message (e.g., DCI and PDSCH) is not received in the remaining paging search spaces in the first paging occasion after the monitoring the one or more remaining paging search spaces in the first paging occasion, the UE may select one or more beams that satisfy an SINR threshold and monitor paging search spaces that correspond to the selected beams in a next paging occasion. In this way, the UE may successfully receive a paging message in the next paging occasion while reducing paging latency. As a result, paging performance is improved, and the UE conserves time, power, processing resources, and signaling resources.

As shown in FIG. 8A and by reference number 830, BS 810 may transmit, in a first paging occasion, paging messages on beams that are configured for the paging messages. As shown by reference number 835, UE 820 may decode a paging DCI in a paging search space that corresponds to the serving beam and may fail to decode a paging PDSCH on the serving beam. UE 820 may then determine whether the paging search space that corresponds to the serving beam is a not a last paging search space in the first paging occasion.

As shown by reference number 840, UE 820 may monitor remaining paging search spaces in the first paging occasion. If a paging message is received, the monitoring stops for the first paging occasion. If a paging message is not received in the remaining paging search spaces in the first paging occasion, UE 820 may determine one or more beams that correspond to one or more paging search spaces of the first paging occasion, as shown by reference number 845. Each beam of the one or more beams may satisfy an SINR threshold, and there may be a maximum quantity of beams to monitor.

For example, if a serving beam is beam 3, UE 820 may keep monitoring paging search spaces for beams 4, 5, and 6. If a paging message is found in any of these paging search spaces, UE 820 may stop monitoring in the first paging occasion and beams may not need to be selected for a second paging occasion. UE 820 may only need to monitor the paging search space for the serving beam in the second paging occasion. If a paging message is not received in beams 4, 5, and 6, beams 0, 1, and/or 2 may have a sufficient SINR. Beams 0, 1, and/or 2 may be selected for monitoring in the second paging occasion.

While the operations discussed herein involve SINR thresholds, in some aspects, operations may also involve, alternatively or additionally, RSRQ thresholds. In some aspects, UE 820 may select beams based at least in part on a descending order of SINR.

As shown in FIG. 8B and by reference number 850, BS 810 may transmit paging messages on beams for the second paging occasion, which may be the next paging occasion after the first paging occasion. As shown by reference number 855, UE 820 may monitor one or more paging search spaces, in the second paging occasion, that correspond to the one or more beams that were selected by UE 820 for the second paging occasion. UE 820 may stop monitoring paging search spaces when a paging message on the PDSCH is successfully decoded. In some aspects, UE 820 may monitor paging search spaces in an increasing order of beam index or SSB identifier. For example, the selected beams may be {5, 3, 1}, where an SINR of SSB #5>SSB #3>SSB #1. Accordingly, UE 820 may first monitor, in the next paging occasion, a paging search space that corresponds to beam 1, a paging search space for beam 3, and then a paging search space for beam 8.

As indicated above, FIGS. 8A-8B are provided as an example. Other examples may differ from what is described with regard to FIGS. 8A-8B.

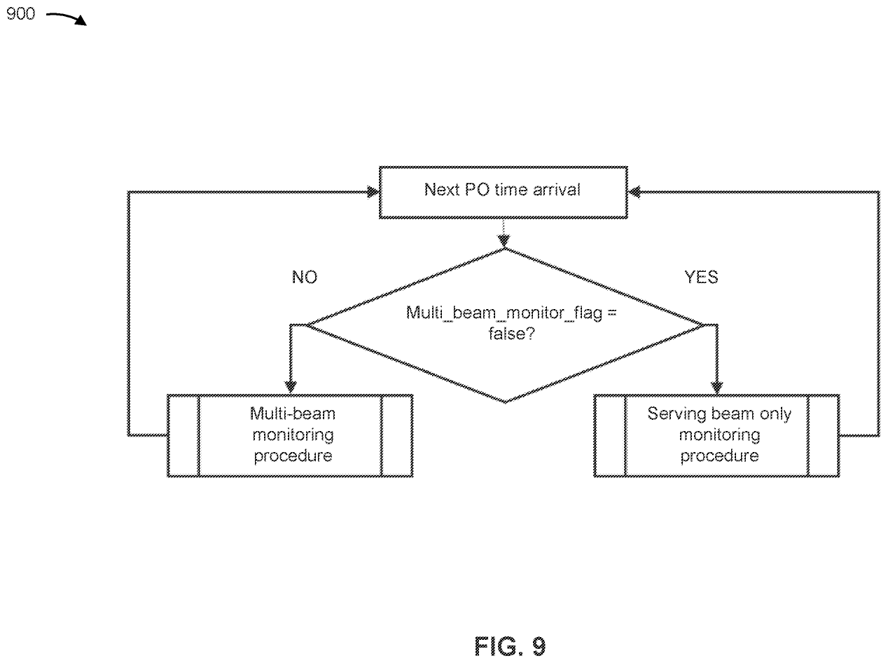

FIG. 9 is a diagram illustrating an example 900 of using a monitor flag, in accordance with the present disclosure. FIG. 9 shows a flowchart for how a UE may use a monitor flag for multiple beams to proceed with monitoring paging search spaces.

In some aspects, a UE may set the monitor flag, in one paging occasion, to indicate multiple beam monitoring for a next paging occasion (e.g., set the monitor flag to true). The UE may determine, based at least in part on the monitor flag, whether to monitor multiple beams or the serving beam only.

As shown by example 900, upon arrival of a paging occasion, the UE may determine whether the monitor flag (e.g., Multi_Beam_monitor_flag) is set to false. If so, the UE may monitor the serving beam only. If the monitor flag is set to true, the UE may monitor the multiple beams that were previously selected.

As indicated above, FIG. 9 is provided as an example. Other examples may differ from what is described with regard to FIG. 9.

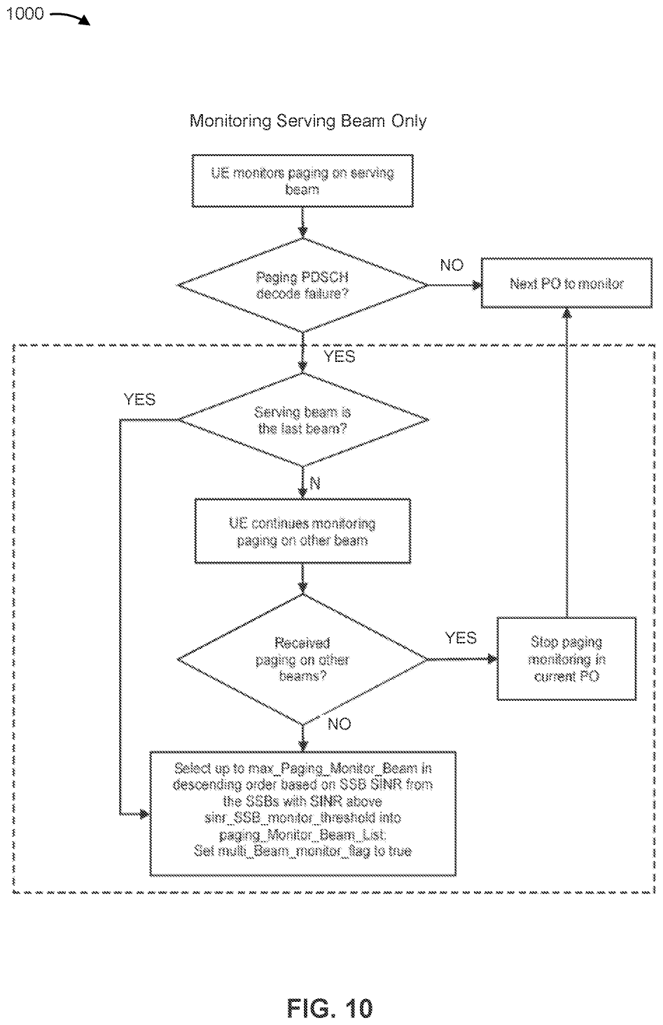

FIG. 10 is a diagram illustrating an example 1000 of a process for monitoring a serving beam only, in accordance with the present disclosure. FIG. 10 shows a flowchart for how a UE may monitor a serving beam only, based at least in part on a monitor flag being set to indicate monitoring for the serving beam only.

The UE may monitor paging search spaces on a serving beam. If there is a failure to decode a paging PDSCH, the UE determines whether the serving beam is the last beam. If so, the UE selects one or more beams up to a maximum beam quantity (e.g., max_Paging_Monitor_Beam) in descending order of SSB SINR. The beams may satisfy a minimum SINR threshold (e.g., sinr_SSB_monitor_threshold). The beams may form a beam list (e.g., paging_Monitor_Beam_List). The UE may set a monitor flag for multiple beam monitoring (e.g., multi_Beam_monitor_flag) to true. The UE may monitor paging search spaces corresponding to the beams in a next paging occasion.

Threshold sinr_SSB_monitor_threshold may be configurable. Threshold max_Paging_Monitor_Beam may be configurable and range, for example, between 1 and 64. Threshold PO_monitor_Max may be configurable and range, for example, between 1 and 50.

If the serving beam is not the last beam, the UE may continue to monitor paging search spaces for other beams. If a paging message (e.g., paging DCI and PDSCH) is received on one of the beams, the UE may stop monitoring for this paging occasion and proceed with monitoring a next paging occasion. However, if a paging message is not received, the UE may select beams for the next paging occasion and set the monitor flag for multiple beam monitoring to true, as explained above.

As indicated above, FIG. 10 is provided as an example. Other examples may differ from what is described with regard to FIG. 10.

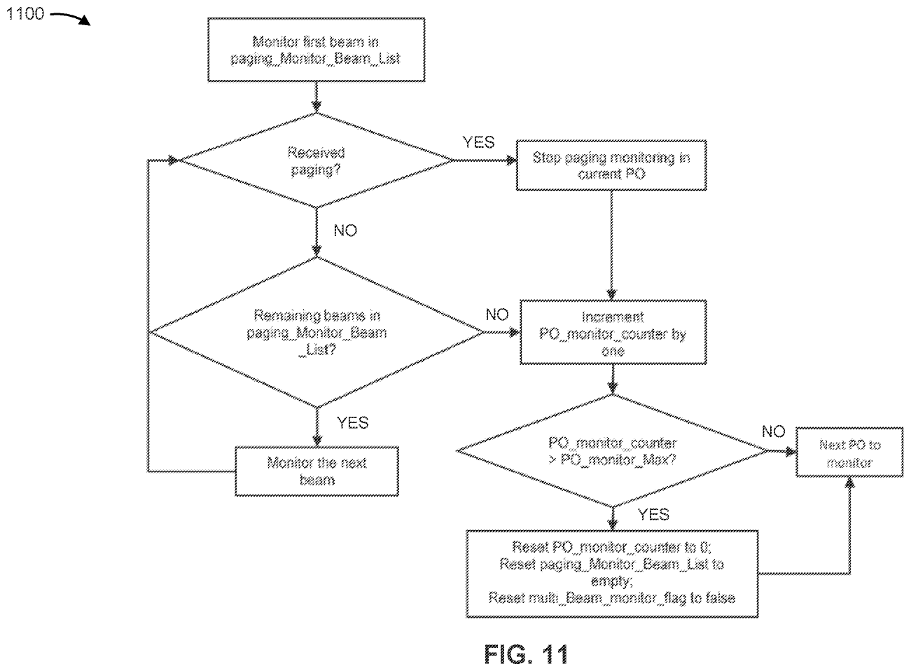

FIG. 11 is a diagram illustrating an example 1100 of a process for monitoring multiple beams, in accordance with the present disclosure. FIG. 11 shows a flowchart for how a UE may monitor multiple beams based at least in part on a monitor flag being set to indicate monitoring multiple beams.

The UE may monitor a paging search space for a first beam in a list of beams (e.g., paging_Monitor_Beam_List) selected in a previous paging occasion. If a paging message is received, the UE may stop monitoring during the paging occasion, and the UE may increment a paging monitor counter.

If a paging message is not received, the UE may proceed to a paging search space for the next beam in the list. If there are no more beams remaining in the list, the UE may increment the paging monitor counter.

In some aspects, if a value of the paging monitor counter satisfies a counter threshold (e.g., exceeds PO_Monitor_Max), the UE may reset the monitor counter to 0, empty the beam list, and reset the monitor flag to false. Otherwise, the UE may proceed with monitoring the next paging occasion.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., a UE 120 depicted in FIGS. 1 and 2, UE 720 depicted in FIGS. 7A and 7B) performs operations associated with selecting beams for a next paging occasion.

As shown in FIG. 12, in some aspects, process 1200 may include determining that a paging search space that corresponds to a serving beam is a last paging search space in a first paging occasion, after determining that the UE decoded a paging DCI in the paging search space and failed to decode a paging PDSCH on the serving beam (block 1210). For example, the UE (e.g., using antenna 252, demodulator 254, MIMO detector 256, receive processor 258, transmit processor 264, TX MIMO processor 266, modulator 254, controller/processor 280, and/or memory 282) may determine that a paging search space that corresponds to a serving beam is a last paging search space in a first paging occasion, after determining that the UE decoded a paging DCI in the paging search space and failed to decode a paging PDSCH on the serving beam, as described above.

As further shown in FIG. 12, in some aspects, process 1200 may include determining one or more beams that correspond to one or more paging search spaces of the first paging occasion based at least in part on the determining that the paging search space is the last paging search space in the first paging occasion, wherein each beam of the one or more beams satisfies an SINR threshold (block 1220). For example, the UE (e.g., using antenna 252, demodulator 254, MIMO detector 256, receive processor 258, transmit processor 264, TX MIMO processor 266, modulator 254, controller/processor 280, and/or memory 282) may determine one or more beams that correspond to one or more paging search spaces of the first paging occasion based at least in part on the determining that the paging search space is the last paging search space in the first paging occasion, wherein each beam of the one or more beams satisfies an SINR threshold, as described above.

As further shown in FIG. 12, in some aspects, process 1200 may include monitoring one or more paging search spaces, in a second paging occasion, that correspond to the one or more beams (block 1230). For example, the UE (e.g., using antenna 252, demodulator 254, MIMO detector 256, receive processor 258, transmit processor 264, TX MIMO processor 266, modulator 254, controller/processor 280, and/or memory 282) may monitor one or more paging search spaces, in a second paging occasion, that correspond to the one or more beams, as described above.

Process 1200 may include additional aspects, such as any single aspect or any combination of aspects described below and/or in connection with one or more other processes described elsewhere herein.

In a first aspect, the monitoring the one or more paging search spaces in the second paging occasion includes monitoring the one or more paging search spaces in an order that corresponds to a descending order of the one or more beams by SINR.

In a second aspect, alone or in combination with the first aspect, a quantity of the one or more beams does not exceed a maximum quantity of beams.

In a third aspect, alone or in combination with one or more of the first and second aspects, the monitoring the one or more paging search spaces in the second paging occasion includes monitoring the one or more paging search spaces in one of an ascending order of SSB identifiers or an ascending order of corresponding beam indices.

In a fourth aspect, alone or in combination with one or more of the first through third aspects, process 1200 includes setting, during the first paging occasion, a monitor flag to indicate multiple beam monitoring.

In a fifth aspect, alone or in combination with one or more of the first through fourth aspects, process 1200 includes incrementing a paging occasion monitor counter based at least in part on the setting the monitor flag to indicate multiple beam monitoring.

In a sixth aspect, alone or in combination with one or more of the first through fifth aspects, process 1200 includes, based at least in part on a determination that a value of the paging occasion monitor counter satisfies a counter threshold, resetting the paging occasion monitor counter to zero, removing the one or more beams from a list of beams to be monitored in a next paging occasion, and setting the monitor flag to indicate serving beam monitoring only.

In a seventh aspect, alone or in combination with one or more of the first through sixth aspects, the monitoring the one or more paging search spaces in the second paging occasion includes monitoring the one or more paging search spaces in the second paging occasion based at least in part on a determination that a monitor flag is set to indicate multiple beam monitoring.

In an eighth aspect, alone or in combination with one or more of the first through seventh aspects, the determining whether the paging search space that corresponds to the serving beam is the last paging search space in the first paging occasion includes determining whether the paging search space that corresponds to the serving beam is the last paging search space in the first paging occasion based at least in part on a determination that a monitor flag is set to serving beam only.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., a UE 120 depicted in FIGS. 1 and 2, UE 820 depicted in FIGS. 8A and 8B) performs operations associated with selecting beams for a next paging occasion.

As shown in FIG. 13, in some aspects, process 1300 may include determining that a paging search space that corresponds to a serving beam is not a last paging search space in a first paging occasion, after determining that the UE decoded a paging DCI in the paging search space and failed to decode a paging PDSCH on the serving beam (block 1310). For example, the UE (e.g., using antenna 252, demodulator 254, MIMO detector 256, receive processor 258, transmit processor 264, TX MIMO processor 266, modulator 254, controller/processor 280, and/or memory 282) may determine that a paging search space that corresponds to a serving beam is not a last paging search space in a first paging occasion, after determining that the UE decoded a paging DC in the paging search space and failed to decode a paging PDSCH on the serving beam, as described above.

As further shown in FIG. 13, in some aspects, process 1300 may include monitoring one or more remaining paging search spaces in the first paging occasion (block 1320). For example, the UE (e.g., using antenna 252, demodulator 254, MIMO detector 256, receive processor 258, transmit processor 264, TX MIMO processor 266, modulator 254, controller/processor 280, and/or memory 282) may monitor one or more remaining paging search spaces in the first paging occasion, as described above.

As further shown in FIG. 13, in some aspects, process 1300 may include determining one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, wherein each beam of the one or more beams satisfies an SINR threshold (block 1330). For example, the UE (e.g., using antenna 252, demodulator 254, MIMO detector 256, receive processor 258, transmit processor 264, TX MIMO processor 266, modulator 254, controller/processor 280, and/or memory 282) may determine one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, wherein each beam of the one or more beams satisfies an SINR threshold, as described above.

As further shown in FIG. 13, in some aspects, process 1300 may include monitoring one or more paging search spaces, in a second paging occasion, that correspond to the one or more beams (block 1340). For example, the UE (e.g., using antenna 252, demodulator 254, MIMO detector 256, receive processor 258, transmit processor 264, TX MIMO processor 266, modulator 254, controller/processor 280, and/or memory 282) may monitor one or more paging search spaces, in a second paging occasion, that correspond to the one or more beams, as described above.

Process 1300 may include additional aspects, such as any single aspect or any combination of aspects described below and/or in connection with one or more other processes described elsewhere herein.

In a first aspect, the monitoring the one or more paging search spaces in the second paging occasion includes monitoring the one or more paging search spaces in an order that corresponds to a descending order of the one or more beams by SINR.

In a second aspect, alone or in combination with the first aspect, a quantity of the one or more beams does not exceed a maximum quantity of beams.

In a third aspect, alone or in combination with one or more of the first and second aspects, the monitoring the one or more paging search spaces in the second paging occasion includes monitoring the one or more paging search spaces in one of an ascending order of SSB identifiers or an ascending order of corresponding beam indices.

In a fourth aspect, alone or in combination with one or more of the first through third aspects, process 1300 includes setting, during the first paging occasion, a monitor flag to indicate multiple beam monitoring.

In a fifth aspect, alone or in combination with one or more of the first through fourth aspects, process 1300 includes incrementing a paging occasion monitor counter based at least in part on the setting the monitor flag to indicate multiple beam monitoring.

In a sixth aspect, alone or in combination with one or more of the first through fifth aspects, process 1300 further comprises, based at least in part on a determination that a value of the paging occasion monitor counter satisfies a counter threshold, resetting the paging occasion monitor counter to zero, removing the one or more beams from a list of beams to be monitored in a next paging occasion, and setting the monitor flag to indicate serving beam monitoring only.

In a seventh aspect, alone or in combination with one or more of the first through sixth aspects, the monitoring the one or more paging search spaces in the second paging occasion includes monitoring the one or more paging search spaces in the second paging occasion based at least in part on a determination that a monitor flag is set to indicate multiple beam monitoring.

In an eighth aspect, alone or in combination with one or more of the first through seventh aspects, the determining whether the paging search space that corresponds to the serving beam is the last paging search space in the first paging occasion includes determining whether the paging search space that corresponds to the serving beam is the last paging search space in the first paging occasion based at least in part on a determination that a monitor flag is set to serving beam only.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

The following provides an overview of some Aspects of the present disclosure:

Aspect 1: A method of wireless communication performed by a user equipment (UE), comprising: monitoring one or more paging search spaces, in a paging occasion, that correspond to one or more beams other than a serving beam based at least in part on a determination that a signal to interference plus noise ratio (SINR) of the serving beam does not satisfy a first SINR threshold; and stopping the monitoring of the one or more paging search spaces in the paging occasion based at least in part on a determination that a paging message in the one or more paging search spaces has been successfully decoded.

Aspect 2: The method of Aspect 1, wherein the paging message includes a synchronization signal block.

Aspect 3: The method of Aspect 1 or 2, further comprising selecting the one or more beams such that each beam of the one or more beams satisfies a second SINR threshold.

Aspect 4: The method of any of Aspects 1-3, wherein a quantity of the one or more beams does not exceed a maximum quantity of beams.

Aspect 5: The method of any of Aspects 1-4, wherein the monitoring the one or more paging search spaces includes monitoring the one or more paging search spaces in an order that is based at least in part on a descending order of SINR for the one or more beams that correspond to the one or more paging search spaces.

Aspect 6: The method of any of Aspects 1-5, wherein the monitoring the one or more paging search spaces includes monitoring the one or more paging search spaces further based at least in part on a determination that a monitor flag to indicate multiple beam monitoring is true.

Aspect 7: The method of any of Aspects 1-6, further comprising setting a monitor flag to indicate multiple beam monitoring to be true based at least in part on a determination that the UE has entered a new cell.

Aspect 8: The method of any of Aspects 1-7, further comprising incrementing a multiple beam monitoring counter based at least in part on a determination that a physical downlink shared channel decoding failure flag is true.

Aspect 9: The method of Aspect 8, further comprising setting a monitor flag to indicate multiple beam monitoring to be false based at least in part on a determination that the multiple beam monitoring counter satisfies a counter threshold.

Aspect 10: The method of any of Aspects 1-9, further comprising setting a physical downlink shared channel decoding failure flag to false.

Aspect 11: A method of wireless communication performed by a user equipment (UE), comprising: determining that a paging search space that corresponds to a serving beam is a last paging search space in a first paging occasion, after determining that the UE decoded a paging downlink control information in the paging search space and failed to decode a paging physical downlink shared channel (PDSCH) on the serving beam; determining one or more beams that correspond to one or more paging search spaces of the first paging occasion based at least in part on the determining that the paging search space is the last paging search space in the first paging occasion, wherein each beam of the one or more beams satisfies a signal to interference plus noise ratio (SINR) threshold; and monitoring one or more paging search spaces, in a second paging occasion, that correspond to the one or more beams.

Aspect 12: The method of Aspect 11, wherein the monitoring the one or more paging search spaces in the second paging occasion includes monitoring the one or more paging search spaces in an order that corresponds to a descending order of the one or more beams by SINR.

Aspect 13: The method of Aspect 11 or 12, wherein a quantity of the one or more beams does not exceed a maximum quantity of beams.

Aspect 14: The method of any of Aspects 11-13, wherein the monitoring the one or more paging search spaces in the second paging occasion includes monitoring the one or more paging search spaces in one of an ascending order of synchronization signal block identifiers or an ascending order of corresponding beam indices.

Aspect 15: The method of any of Aspects 11-14, further comprising setting, during the first paging occasion, a monitor flag to indicate multiple beam monitoring.

Aspect 16: The method of Aspect 15, further comprising incrementing a paging occasion monitor counter based at least in part on the setting the monitor flag to indicate multiple beam monitoring.

Aspect 17: The method of Aspect 16, further comprising, based at least in part on a determination that a value of the paging occasion monitor counter satisfies a counter threshold, resetting the paging occasion monitor counter to zero, removing the one or more beams from a list of beams to be monitored in a next paging occasion, and setting the monitor flag to indicate serving beam monitoring only.

Aspect 18: The method of any of Aspects 11-17, wherein the monitoring the one or more paging search spaces in the second paging occasion includes monitoring the one or more paging search spaces in the second paging occasion based at least in part on a determination that a monitor flag is set to indicate multiple beam monitoring.

Aspect 19: The method of any of Aspects 11-18, wherein the determining whether the paging search space that corresponds to the serving beam is the last paging search space in the first paging occasion includes determining whether the paging search space that corresponds to the serving beam is the last paging search space in the first paging occasion based at least in part on a determination that a monitor flag is set to serving beam only.

Aspect 20: A method of wireless communication performed by a user equipment (UE), comprising: determining that a paging search space that corresponds to a serving beam is not a last paging search space in a first paging occasion, after determining that the UE decoded a paging downlink control information in the paging search space and failed to decode a paging physical downlink shared channel (PDSCH) on the serving beam; monitoring one or more remaining paging search spaces in the first paging occasion; determining one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, wherein each beam of the one or more beams satisfies a signal to interference plus noise ratio (SINR) threshold; and monitoring one or more paging search spaces, in a second paging occasion, that correspond to the one or more beams.

Aspect 21: The method of Aspect 20, wherein the monitoring the one or more paging search spaces in the second paging occasion includes monitoring the one or more paging search spaces in an order that corresponds to a descending order of the one or more beams by SINR.

Aspect 22: The method of Aspect 20 or 21, wherein a quantity of the one or more beams does not exceed a maximum quantity of beams.

Aspect 23: The method of any of Aspects 20-22, wherein the monitoring the one or more paging search spaces in the second paging occasion includes monitoring the one or more paging search spaces in one of an ascending order of synchronization signal block identifiers or an ascending order of corresponding beam indices.

Aspect 24: The method of any of Aspects 20-23, further comprising setting, during the first paging occasion, a monitor flag to indicate multiple beam monitoring.

Aspect 25: The method of Aspect 24, further comprising incrementing a paging occasion monitor counter based at least in part on the setting the monitor flag to indicate multiple beam monitoring.

Aspect 26: The method of Aspect 25, further comprising, based at least in part on a determination that a value of the paging occasion monitor counter satisfies a counter threshold, resetting the paging occasion monitor counter to zero, removing the one or more beams from a list of beams to be monitored in a next paging occasion, and setting the monitor flag to indicate serving beam monitoring only.

Aspect 27: The method of any of Aspects 20-26, wherein the monitoring the one or more paging search spaces in the second paging occasion includes monitoring the one or more paging search spaces in the second paging occasion based at least in part on a determination that a monitor flag is set to indicate multiple beam monitoring.

Aspect 28: The method of any of Aspects 20-27, wherein the determining whether the paging search space that corresponds to the serving beam is the last paging search space in the first paging occasion includes determining whether the paging search space that corresponds to the serving beam is the last paging search space in the first paging occasion based at least in part on a determination that a monitor flag is set to serving beam only.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware, firmware, and/or a combination of hardware and software.

It will be apparent that systems and/or methods described herein may be implemented in different forms of hardware, software, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory; and
one or more processors coupled to the memory, the memory comprising instructions executable by the one or more processors to cause the UE to:
monitor one or more paging search spaces, in a paging occasion, that correspond to one or more beams other than a serving beam based at least in part on a determination that a signal to interference plus noise ratio (SINR) of the serving beam does not satisfy a first SINR threshold; and
stop the monitoring of the one or more paging search spaces in the paging occasion based at least in part on a determination that a paging message in the one or more paging search spaces has been successfully decoded.

2. The UE of claim 1, wherein the paging message includes a synchronization signal block.

3. The UE of claim 1, wherein the memory further comprises instructions executable by the one or more processors to cause the UE to select the one or more beams such that each beam of the one or more beams satisfies a second SINR threshold.

4. The UE of claim 1, wherein a quantity of the one or more beams does not exceed a maximum quantity of beams.

5. The UE of claim 1, wherein the memory further comprises instructions executable by the one or more processors to cause the UE to monitor the one or more paging search spaces in an order that is based at least in part on a descending order of SINR for the one or more beams that correspond to the one or more paging search spaces.

6. The UE of claim 1, wherein the memory further comprises instructions executable by the one or more processors to cause the UE to monitor the one or more paging search spaces further based at least in part on a determination that a monitor flag to indicate multiple beam monitoring is true.

7. The UE of claim 1, wherein the memory further comprises instructions executable by the one or more processors to cause the UE to set a monitor flag to indicate multiple beam monitoring to be true based at least in part on a determination that the UE has entered a new cell.

8. The UE of claim 1, wherein the memory further comprises instructions executable by the one or more processors to cause the UE to increment a multiple beam monitoring counter based at least in part on a determination that a physical downlink shared channel decoding failure flag is true.

9. The UE of claim 8, wherein the memory further comprises instructions executable by the one or more processors to cause the UE to set a monitor flag to indicate multiple beam monitoring to be false based at least in part on a determination that the multiple beam monitoring counter satisfies a counter threshold.

10. The UE of claim 1, wherein the memory further comprises instructions executable by the one or more processors to cause the UE to set a physical downlink shared channel decoding failure flag to false.

11. A user equipment (UE) for wireless communication, comprising:
memory, and
one or more processors coupled to the memory, the memory comprising instructions executable by the one or more processors to cause the UE to:
determine that a paging search space that corresponds to a serving beam is a last paging search space in a first paging occasion, after determining that the UE decoded a paging downlink control information in the paging search space and failed to decode a paging physical downlink shared channel (PDSCH) on the serving beam;
determine one or more beams that correspond to one or more paging search spaces of the first paging occasion based at least in part on the determining that the paging search space is the last paging search space in the first paging occasion, wherein each beam of the one or more beams satisfies a signal to interference plus noise ratio (SINR) threshold, and
monitor one or more paging search spaces, in a second paging occasion, that correspond to the one or more beams.

12. The UE of claim 11, wherein the memory further comprises instructions executable by the one or more processors to cause the UE to monitor the one or more paging search spaces in an order that corresponds to a descending order of the one or more beams by SINR.

13. The UE of claim 11, wherein the memory further comprises instructions executable by the one or more processors to cause the UE to monitor the one or more paging search spaces in one of an ascending order of synchronization signal block identifiers or an ascending order of corresponding beam indices.

14. The UE of claim 11, wherein the memory further comprises instructions executable by the one or more processors to cause the UE to set, during the first paging occasion, a monitor flag to indicate multiple beam monitoring.

15. The UE of claim 14, wherein the memory further comprises instructions executable by the one or more processors to cause the UE to increment a paging occasion monitor counter based at least in part on the setting the monitor flag to indicate multiple beam monitoring.

16. The UE of claim 15, wherein the memory further comprises instructions executable by the one or more processors to cause the UE to, based at least in part on a determination that a value of the paging occasion monitor counter satisfies a counter threshold, reset the paging occasion monitor counter to zero, remove the one or more beams from a list of beams to be monitored in a next paging occasion, and set the monitor flag to indicate serving beam monitoring only.

17. The UE of claim 11, wherein the memory further comprises instructions executable by the one or more processors to cause the UE to monitor the one or more paging search spaces in the second paging occasion based at least in part on a determination that a monitor flag is set to indicate multiple beam monitoring.

18. The UE of claim 11, wherein the memory further comprises instructions executable by the one or more processors to cause the UE to determine whether the paging search space that corresponds to the serving beam is the last paging search space in the first paging occasion based at least in part on a determination that a monitor flag is set to serving beam only.

19. A user equipment (UE) for wireless communication, comprising:
memory; and
one or more processors coupled to the memory, the memory comprising instructions executable by the one or more processors to cause the UE to:
determine that a paging search space that corresponds to a serving beam is not a last paging search space in a first paging occasion, after determining that the UE decoded a paging downlink control information in the paging search space and failed to decode a paging physical downlink shared channel (PDSCH) on the serving beam;
monitor one or more remaining paging search spaces in the first paging occasion;
determine one or more beams that correspond to one or more paging search spaces of the first paging occasion based at least in part on a determination that a paging message is not received in the remaining paging search spaces in the first paging occasion after the monitoring the one or more remaining paging search spaces in the first paging occasion, wherein each beam of the one or more beams satisfies a signal to interference plus noise ratio (SINR) threshold; and
monitor one or more paging search spaces, in a second paging occasion, that correspond to the one or more beams.

20. The UE of claim 19, wherein the memory further comprises instructions executable by the one or more processors to cause the UE to monitor the one or more paging search spaces in one of an ascending order of synchronization signal block identifiers or an ascending order of corresponding beam indices.

21. The UE of claim 19, wherein the memory further comprises instructions executable by the one or more processors to cause the UE to set, during the first paging occasion, a monitor flag to indicate multiple beam monitoring.

22. The UE of claim 21, wherein the memory further comprises instructions executable by the one or more processors to cause the UE to increment a paging occasion monitor counter based at least in part on the setting the monitor flag to indicate multiple beam monitoring.

23. The UE of claim 22, wherein the memory further comprises instructions executable by the one or more processors to cause the UE to, based at least in part on a determination that a value of the paging occasion monitor counter satisfies a counter threshold, reset the paging occasion monitor counter to zero, remove the one or more beams from a list of beams to be monitored in a next paging occasion, and set the monitor flag to indicate serving beam monitoring only.

24. The UE of claim 19, wherein the memory further comprises instructions executable by the one or more processors to cause the UE to monitor the one or more paging search spaces in the second paging occasion based at least in part on a determination that a monitor flag is set to indicate multiple beam monitoring.

25. The UE of claim 19, wherein the memory further comprises instructions executable by the one or more processors to cause the UE to determine whether the paging search space that corresponds to the serving beam is the last paging search space in the first paging occasion based at least in part on a determination that a monitor flag is set to serving beam only.

26. A method of wireless communication performed by a user equipment (UE), comprising:
monitoring one or more paging search spaces, in a paging occasion, that correspond to one or more beams other than a serving beam based at least in part on a determination that a signal to interference plus noise ratio (SINR) of the serving beam does not satisfy a first SINR threshold; and
stopping the monitoring of the one or more paging search spaces in the paging occasion based at least in part on a determination that a paging message in the one or more paging search spaces has been successfully decoded.

27. The method of claim 26, wherein a quantity of the one or more beams does not exceed a maximum quantity of beams.

28. The method of claim 26, wherein the monitoring the one or more paging search spaces includes monitoring the one or more paging search spaces further based at least in part on a determination that a monitor flag to indicate multiple beam monitoring is true.

29. The method of claim 26, further comprising setting a monitor flag to indicate multiple beam monitoring to be true based at least in part on a determination that the UE has entered a new cell.

30. The method of claim 26, further comprising:
incrementing a multiple beam monitoring counter based at least in part on a determination that a physical downlink shared channel decoding failure flag is true; and
setting a monitor flag to indicate multiple beam monitoring to be false based at least in part on a determination that the multiple beam monitoring counter satisfies a counter threshold.
